(19) United States
(12) Patent Application Publication
(10) Pub. No.: US 2012/0266520 A1
(43) Pub. Date: Oct. 25, 2012

(54) STINK BUG TRAP

(76) Inventor: Andrew Paul Strube, Columbia, PA (US)

(21) Appl. No.: 13/275,616

(22) Filed: Oct. 18, 2011

Related U.S. Application Data
(60) Provisional application No. 61/394,437, filed on Oct. 19, 2010.

(51) Int. Cl. A01M 1/14; A01M 1/02; A01M 1/10

(52) U.S. Cl. 43/114

(57) ABSTRACT

A stink bug trap can include a trap panel and at least one coupling member that extends from the trap panel and is configured to couple the trap panel to a target surface. The trap panel includes a first sticky surface. The first sticky surface of the trap panel faces the target surface when the trap panel is coupled to the target surface, and at least a major portion of the first sticky surface of the trap panel is spaced apart from the target surface by a distance that is between about 0.125 inches and about 1.5 inches when the trap panel is coupled to the target surface.

### CROSS REFERENCE TO RELATED APPLICATIONS

This application claims the benefit of U.S. Provisional Application Ser. No. 61/394,437 filed Oct. 19, 2010, the disclosure of which is hereby incorporated by reference as set forth in its entirety herein.

### BACKGROUND

Stink bugs, which belong to a super family of insects known as pentatomoidea, can be pests in a home or other building that is located within an infested area. Stink bugs will enter these homes or other buildings through cracks around windows, doors, siding, utility pipes, and other openings into the buildings. Because light and heat may pass through windows, large amounts of stink bugs may generally be found proximate to the windows of the building located within the infested area whether there is a crack around the window or not. Therefore, windows may be an ideal location to find and eliminate stink bugs before they enter the building.

Exterior applications of insecticides have been used and may offer some minor relief from infestations where the task of completely sealing the exterior is difficult or impossible. Unfortunately, because insecticides are broken down by sunlight, the residual effect of the material will be greatly decreased and may not kill the insects much beyond several days or a week.

Additionally, some nontoxic methods have been used to control stink bugs. For example, stink bugs are attracted to the color yellow, and yellow sticky traps for trapping stink bugs have been used. Such traps will often times be impregnated with a pheromone to lure the stink bugs to the traps, and once they land on the sticky portion of the trap, the stink bugs will be trapped and then subsequently disposed of Known traps, however, are still as effective as they need to be, and are not capable of being located in certain areas, for example, proximate to the windows of a building.

### SUMMARY

In one embodiment a stink bug trap includes a trap panel and at least one coupling member that extends from the trap panel along a lateral direction. The trap panel includes an inner sticky surface and an opposed outer sticky surface. The inner sticky surface is configured to immobilize a stink bug. The at least one coupling member extends from the trap panel along a lateral direction that extends from the outer surface toward the inner sticky surface. The at least one coupling member is configured to couple the trap panel to a target surface and has a lateral width that is between about 0.125 inches and about 1.5 inches such that at least a major portion of the inner sticky surface of the trap panel is spaced apart from the target surface by a distance that is between about 0.125 inches and about 1.5 inches when the stink bug trap is coupled to the target surface.

In another embodiment a stink bug trap is configured to be coupled to a window frame for a window. The window frame has at least a first dimension. The stink bug trap includes a trap panel that includes a panel body that has at least one dimension that is substantially equal to the first dimension such that the trap panel is configured to have an interference fit with the window frame for the window to thereby couple the stink bug trap to the window frame. The panel body includes an inner sticky surface configured to immobilize stink bugs, and an opposed outer surface, and defines a plurality of strips that are each separated by a slot that extends laterally through the panel body. The stink bug trap is configured to be coupled to the window frame such that the inner sticky surface of the panel body is spaced apart from the window by a gap.

In another embodiment a method of trapping stink bugs can include providing a stink bug trap that includes a trap panel and at least one coupling member that extends from the trap panel along a lateral direction. The trap panel can have an inner sticky surface that is configured to immobilize a stink bug. The at least one coupling member has a lateral width that is between about 0.125 inches and about 1.5 inches. The method further includes the step of attaching the stink bug trap to a window such that the stink bug trap is positioned proximate to a corner of the window, and the inner sticky surface faces the window and is spaced apart from the window by a gap that is substantially equal to the lateral width of the at least one coupling member.

### BRIEF DESCRIPTION OF THE DRAWINGS

The foregoing summary, as well as the following detailed description of exemplary embodiments, will be better understood when read in conjunction with the appended drawings, in which there is shown in the drawings example embodiments for the purposes of illustration. It should be understood, however, that the application is not limited to the precise arrangements and systems shown. In the drawings:

FIG. 1A is a perspective view of a stink bug trap constructed in accordance with an embodiment, the stink bug trap being coupled to a window;

FIG. 1B is a side cross-sectional view of the stink bug trap shown in FIG. 1A coupled to the window;

FIG. 2A is a perspective view of the stink bug trap shown in FIG. 1A, the stink bug trap including a trap panel having at least a first inner sticky surface, and a coupling member configured to couple the trap panel to a target surface;

FIG. 2B is a side elevation view of the stink bug trap shown in FIG. 2A;

FIG. 2C is a back plan view of the stink bug trap show in FIG. 2A;

FIG. 3A is a back perspective view of a stink bug trap constructed in accordance with another embodiment, the stink bug trap including a trap panel having first and second side walls that define a corner;

FIG. 3B is a side elevation view of the stink bug trap shown in FIG. 3A;

FIG. 4 is a perspective view of a stink bug trap constructed in accordance with another embodiment, the stink bug trap including a trap panel that has a plurality of strips that are each separated by a slot;

FIG. 5A is a perspective view of a stink bug trap constructed in accordance with another embodiment, the stink bug trap coupled to a recessed portion of a screen for a pre-existing window; and

FIG. 5B is a perspective view of the stink bug trap shown in FIG. 5A, the stink bug trap including a trap panel, and a coupling member that is configured to create an interference fit with the recessed portion of the screen for the pre-existing window.

### DETAILED DESCRIPTION OF ILLUSTRATIVE EMBODIMENTS

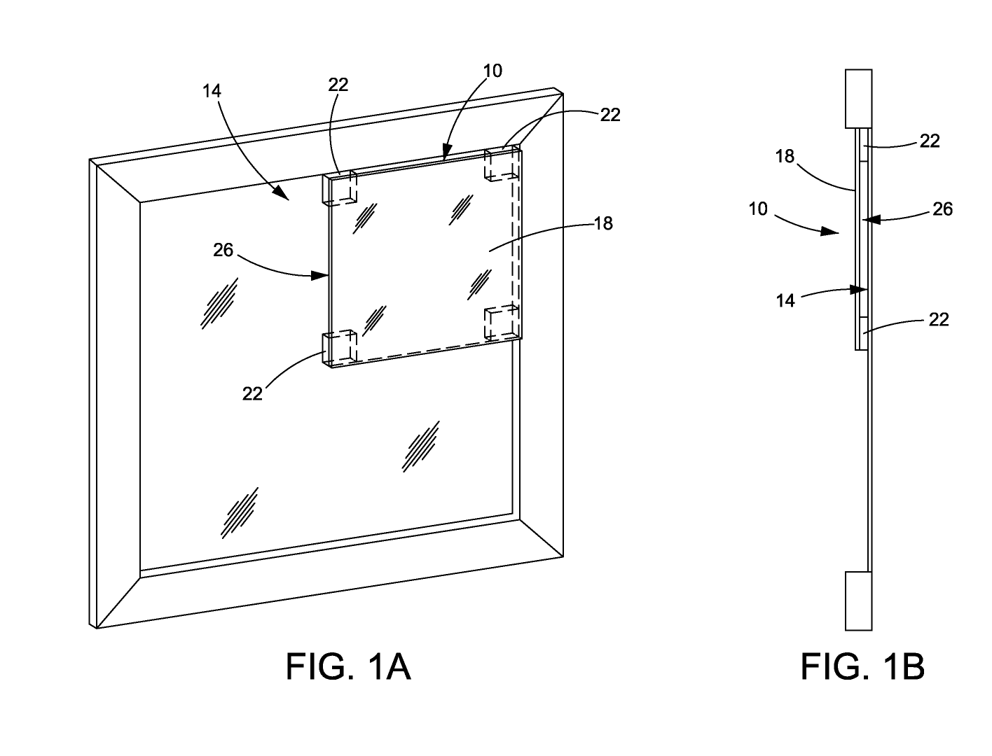

Referring to FIGS. 1A and 1B, a stink bug trap 10 is configured to lure and trap stink bugs that collect on or around a target surface 14, such as a window, to thereby eliminate the stink bugs from the area on or around the target surface 14. The stink bug trap 10 can include a trap panel 18 and at least one, such as four coupling members 22 that extend from the trap panel 18. The coupling members 22 are configured to couple the trap panel 18 to the target surface 14 such that a gap 26 is defined between the target surface 14 and the trap panel 18. In the illustrated embodiment, the stink bug trap 10 can be coupled to a glass surface of a window such that the sting bug trap 10 is located in a corner of the window. The location of the stink bug trap 14 along with the gap 26 defined between the glass surface and the trap panel 18 provides an environment that is attractive to stink bugs and thus lures them into the gap 26. Once in the gap 26, the stink bugs will eventually get trapped or otherwise be immobilized and thus be eliminated from the surrounding area. It should be understood that the stink bug trap 14 may be positioned in other locations to thereby provide an environment that lures the stink bugs into the trap 14.

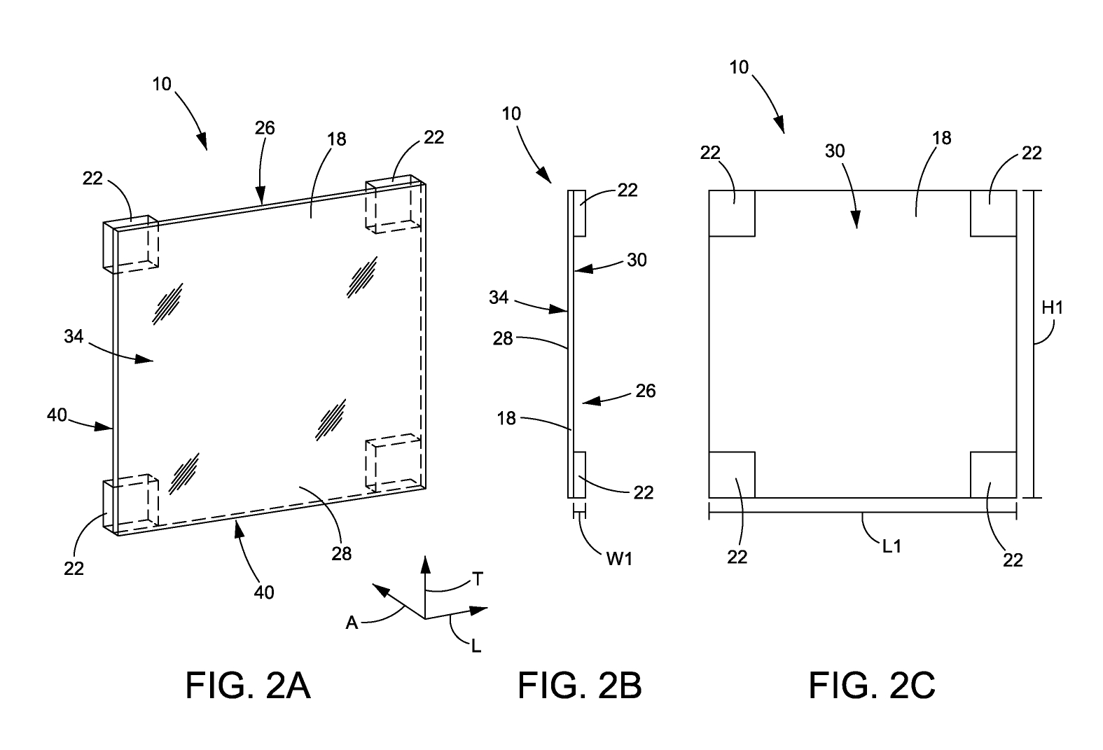

As shown in FIG. 2A-2C, the trap panel 18 can be a rectangular shaped substantially flat member 28 and can define a first or inner sticky surface 30 and a second or outer sticky surface 34 that is opposed to the first sticky surface 30. At least a major portion of the first sticky surface 30 is configured to face the target surface 14 when the trap panel 18 is coupled to the target surface 14, and at least a major portion of the second surface 34 is configured to face away from the target surface 14 when the trap panel 18 is coupled to the target surface 14. The first and second sticky surfaces 30 and 34 are configured to immobilize the stink bugs when they come into contact with any portion of the sticky surfaces 30 and 34. The sticky surfaces 30 and 34 may be made from a variety of known tacky adhesives. It should be understood, however, that the sticky surfaces 30 and 34 may be made from any material, as desired. For example, the sticky surfaces 30 and 34 may be provided as a tape or covering that is placed on the flat member 28. Moreover, it should be understood that the substantially flat member 28 may be made from any known material, such as plastic, wood, glass, etc. Moreover, it should be understood that the trap panel 18 may be a flexible material, such as a tape, that includes at least the first sticky surface 30.

The trap panel 18 can be rectangular in shape and may be configured to be located in a corner of a window. The trap panel 18 can define a longitudinal length L₁ that extends along a longitudinal direction “L” and a transverse height H₁ that extends along a transverse direction “T.” The length L₁ may be between about 10 inches and about 26 inches, and the height H₁ may be between about 6 inches and about 16 inches. It should be understood, however, that the trap panel 18 may have any desired shape, and any desired length or height.

The trap panel 18 may be impregnated with or otherwise include an insect attractant. Such an attractant may be a combination of fruit and vegetable scents or any other scents as desired. The insect attractant can be specifically made to attract stink bugs to the stink bug trap 10. The insect attractant may be applied with an eye dropper or other device. It should be understood, however, that the insect attractant may be any combination of scents and may be made to attract any insect as desired.

As shown in FIGS. 2B and 2C, the coupling members 22 can each extend from a respective corner of a back surface of the trap panel 18 along a lateral direction “A” that extends from the second surface toward the first surface and is perpendicular to both the longitudinal and transverse directions. The coupling members 22 extend from the trap panel 18 such that when the coupling members 22 couple the trap panel 18 to the target surface 14, the first sticky surface 30 faces the target surface 14. Each coupling member 22 may be a double sided sticky pad that includes a temporary adhesive that is configured to temporarily couple the stink bug trap 10 to the target surface 14. It should be understood, however, that the coupling members 22 may have other configurations. For example, the coupling members 22 may also include suction cups, clips, or hooks. Moreover, it should be understood that the coupling members 22 may be separate components from the trap panel 18 as shown, or they may be integrally formed with the trap panel 18, as desired.

As shown in FIG. 2B, the coupling members 22 can each have a lateral width W₁ relative to the first surface 30 and measured along the lateral direction “A.” The width W₁ of the coupling members 22 can be substantially equal to the width of the gap 26. The width W₁ of the coupling members 22, and thus the gap 26 can each be between about 0.125 inches and about 1.5 inches, more particularly between about 0.25 inches and about 0.75 inches, and even more particularly about 0.25 inches. Therefore, the first sticky surface 30 of the trap panel 18 will be spaced apart from the target surface 14 by a distance that is between about 0.125 inches and about 1.5 inches, more particularly between about 0.25 inches and about 0.75 inches, and even more particularly about 0.25 inches when the trap panel 18 is coupled to the target surface 14. As shown in FIG. 2C, the position of the coupling members 22 and the width W₁ of the coupling members 22 provides for four possible openings or entries 40 into the gap 26.

In operation, the stink bug trap 10 can be coupled to a glass surface of a window or other target surface 14 such that the stink bug trap 10 is located in the corner of the window and two of the openings 40 are blocked. The location of the stink bug trap 10 along with the gap 26 defined between the trap panel 18 and the glass surface 14 will simulate an environment that is typically desirable to stink bugs and thus lure the stink bugs into the gap 26 through the remaining two openings or entries 40. The stink bugs will enter the gap 26 and eventually stretch their legs which will bring them into contact with the first sticky surface 30. The stink bugs will then be stuck to the trap panel 18 and therefore be immobilized. Because the trap panel 18 further includes a second sticky surface 34, the stink bugs may also get stuck to the second sticky surface 34 if they fly and land or otherwise move onto the second sticky surface 34. Once the stink bug trap 10 is full, the stink bug trap 10 may be removed from the window or other target surface 14 and may be replaced by a new stink bug trap 10.

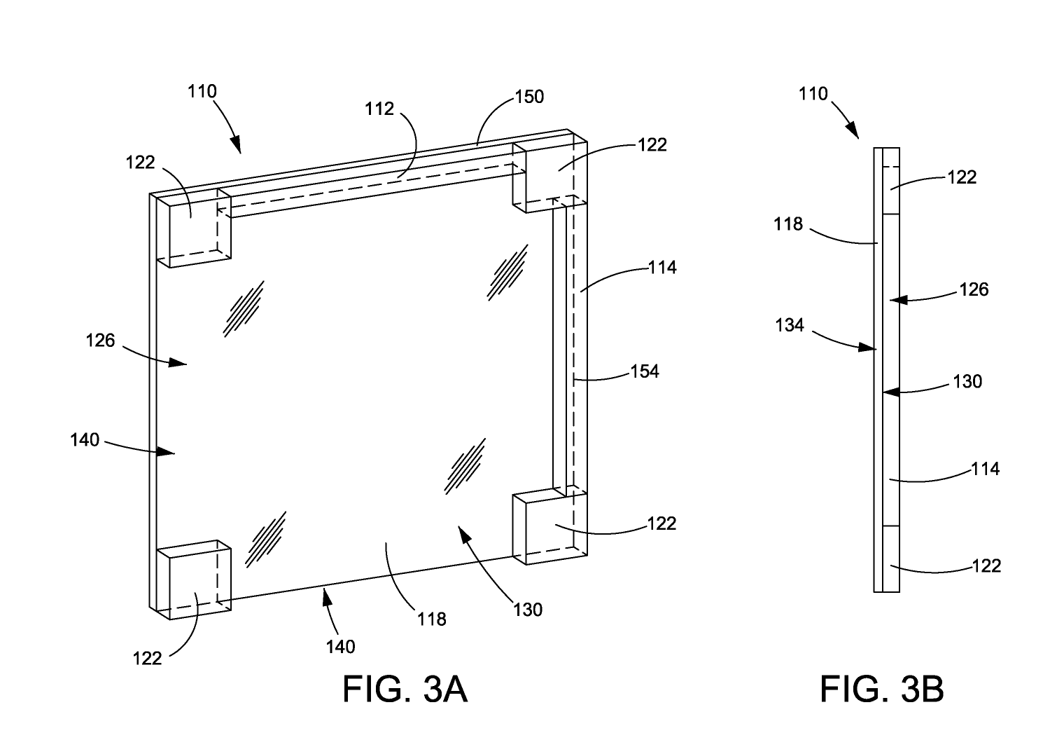

According to another embodiment and in reference to FIGS. 3A and 3B, a stink bug trap 110 includes first and second side walls 112 and 114 that are configured to define a corner. The stink bug trap 110 is configured to be coupled to a target surface, such as a glass surface of a window. Because the stink bug trap 110 includes first and second side walls 112 and 114 that define a corner, the stink bug trap 110 may be located anywhere on the window and still simulate an environment that is typically desirable to stink bugs and thus lure the stink bugs into the stink bug trap 110.

As shown in FIGS. 3A and 3B, the stink bug trap 110 can include a trap panel 118 and at least one, such as four coupling members 122 that extend from the trap panel 118 such that when the stink bug trap 110 is coupled to the target surface a gap 126 is defined between the trap panel 118 and the target surface. The trap panel 118 includes a substantially flat member 128 that includes a first or inner sticky surface 130 and a second or outer sticky surface 134 that is opposed to the first sticky surface 130. At least a major portion of the first sticky surface 130 is configured to face the target surface 14 when the trap panel 118 is coupled to the target surface 114, and at least a major portion of the second surface 134 is configured to face away from the target surface 14 when the trap panel 118 is coupled to the target surface 14. The first and second sticky surfaces 130 and 134 are configured to immobilize the stink bugs when they come into contact with any portion of the sticky surfaces 130 and 134.

The trap panel 118 defines at least a first side 150 and a second side 154 that is adjacent to the first side 150. The first side wall 112 extends in the lateral direction from the first side 150 of the trap panel 118 and the second side wall 114 extends in the lateral direction from the second side 154 of the trap panel 118. The first and second side walls 112 and 114 are joined at their ends so as to define a corner 156. The first and second side walls 112 and 114 extend laterally from a back surface of the trap panel 118. The first and second side walls 112 and 114 have a lateral width that is either equal to or less than the lateral width of the coupling members 122. Moreover, the first and second side walls 112 and 114 can extend along the entire length of the first and second sides 150 and 154 as shown, or along a portion of the first and second sides 150 and 154. Because of the side walls 112 and 114, the stink bug trap 110 may be placed anywhere on the target surface and simulate a desirable environment (i.e. a crack) for stink bugs to enter the trap. For example, the stink bug trap 110 defines openings 140 that allow the lured stink bugs to enter the gap 126 and ultimately get stuck to the trap panel 118. It should be understood, however, that the trap panel 118 may be circular and may include a single side wall that extends partially around a side of the circular trap panel 118 to thereby define a corner.

As shown in FIG. 3B, the coupling members 22 can each extend from a respective corner of the inner surface of the trap panel 118. The coupling members 122 extend from the trap panel 118 along the lateral direction such that when the coupling members 122 couple the trap panel 118 to the target surface 14, the first sticky surface 130 faces the target surface 14. Each coupling member 122 may be a double sided sticky pad that includes a temporary adhesive that is configured to temporarily couple the stink bug trap 110 to the target surface 14. It should be understood, however, that the coupling members 122 may have other configurations. For example, the coupling members 22 may also include suction cups, clips, or hooks.

The stink bug trap 110 is otherwise similar to the stink bug trap 10 shown in FIGS. 2A-2C. That is, the stink bug trap 110 and its components may be made from similar materials as that of the stink bug trap 10, and may have similar shapes and dimensions as that of the stink bug trap 10. For example, as with the stink bug trap shown in FIGS. 2A-2C, the first sticky surface 130 of the trap panel 118 of the stink bug trap 110 will be spaced apart from the target surface 14 by a distance that is between about 0.125 inches and about 1.5 inches, more particularly between about 0.25 inches and about 0.75 inches, and even more particularly about 0.25 inches when the trap panel 118 is coupled to the target surface 14. Moreover, the stink bug trap 110 may operate in a similar manner as the stink bug trap 10, and may be replaced with a new stink bug trap after the initial trap gets full.

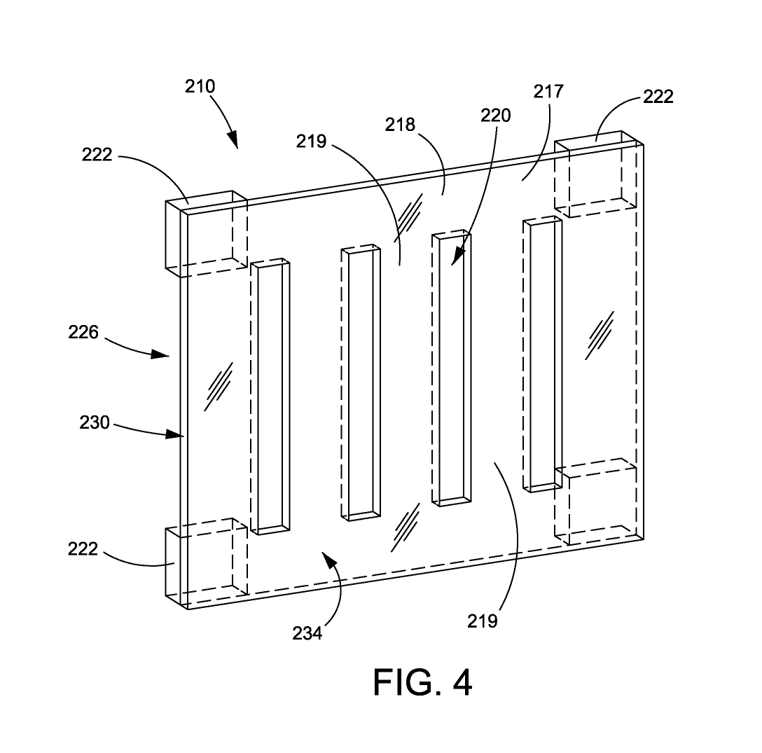

According to another embodiment and in reference to FIG. 4, a stink bug trap 210 includes a trap panel 218 and at least one coupling member 222 extending from the trap panel 218. The trap panel 218 has a panel body 217 that defines a plurality of strips 219 that are each separated by a slot 220 that extends laterally through the panel body 217. The stink bug trap 210 may be coupled to a target surface such that air may pass through the trap panel 218 and a gap 226 is defined between the strips 219 and the window. Therefore, the stink bug trap 210 may be coupled to the window so that air may pass through the slots 220 while the strips 219 trap the stink bugs.

The panel body 217 has a first or inner sticky surface 230 and a second or outer sticky surface 234 that opposes the first sticky surface 230. For example, each strip 219 of the trap panel 218 can define the first sticky surface 230 and the second sticky surface 234. Therefore, when the stink bug trap 210 is coupled to the target surface, at least a majority of the first sticky surface 230 faces the target surface while at least a majority of the second sticky surface 234 faces away from the target surface.

The stink bug trap 210 is otherwise similar to the stink bug trap 10 shown in FIGS. 2A-2C. That is, the stink bug trap 210 and its components may be made from similar materials as that of the stink bug trap 10, and may have similar shapes and dimensions as that of the stink bug trap 10. For example, as with the stink bug trap shown in FIGS. 2A-2C, the first sticky surfaces 230 of the trap panel 218 of the stink bug trap 210 will be spaced apart from the target surface 14 by a distance that is between about 0.125 inches and about 1.5 inches, more particularly between about 0.25 inches and about 0.75 inches, and even more particularly about 0.25 inches when the trap panel 118 is coupled to the target surface 14. Moreover, the stink bug trap 210 may operate in a similar manner as the stink bug trap 10, and may be replaced with a new stink bug trap after the initial trap gets full.

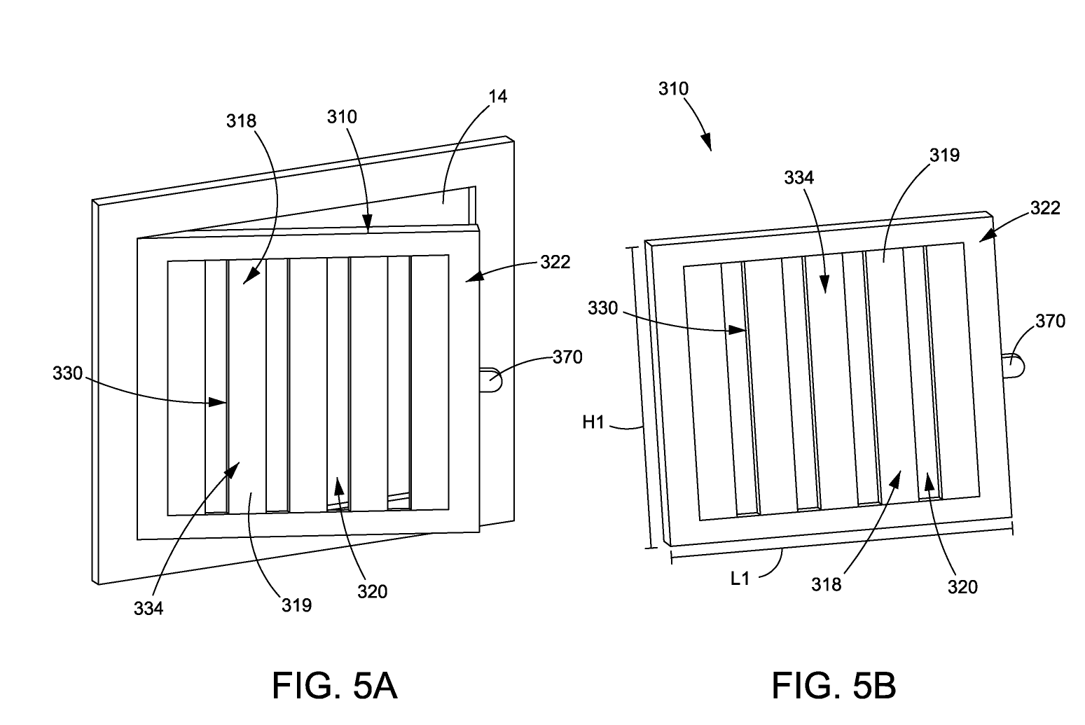

According to another embodiment and in reference to FIGS. 5A and 5B, a stink bug trap 310 includes a trap panel 318 that has a panel body 322. The panel body 322 has at least one dimension that is substantially equal to a dimension of a window frame for a window such that the trap panel 318 is configured to be coupled to the window frame through an interference fit. For example, the trap panel 318 can have a longitudinal length L₁ and a transverse height H₁ that are both substantially equal to a longitudinal length and a transverse height respectively of the window frame. It should be understood, however, that the trap panel 318 can be sized to have only a longitudinal length or only a transverse height (but not both) that is substantially equal to a dimension of the window frame.

As shown in FIG. 5B, the panel body 322 can include a plurality of strips 319 that are each separated by a slot 320 that extends laterally through the panel body 322. The stink bug trap 310 may be coupled to a target surface such as a window frame and allow air to pass through the trap panel 318. That is, the stink bug trap 310 may be coupled to the window frame and air may pass through the slots 320 while the strips 319 trap the stink bugs.

The trap panel 318 (or at least each strip 319 of the trap panel 318) can define a first or inner sticky surface 330 and a second or outer sticky surface 334 that opposes the first sticky surface 330. Therefore, when the stink bug trap 310 is coupled to the window, at least a majority of the first sticky surface 330 faces the window while at least a majority of the second sticky surface 334 faces away from the window. Moreover, a gap 326 is defined between a majority of the first sticky surface 330 and the window when the stink bug trap 310 is coupled to the window.

As shown in FIG. 5B, the trap panel 318 is sized or otherwise configured to provide an interference fit with a window frame of a window. It should be understood, however, that the window frame includes other components for the window including a recessed portion of a window screen for the window.

As shown in FIG. 5B, the stink bug trap 310 can further include a disengagement mechanism 370 that aids in the removal of the stink bug trap 310 from the window frame. In the illustrated embodiment, the disengagement mechanism 370 is a flexible material that protrudes laterally out from the trap panel 318. It should be understood, however, that the disengagement mechanism 370 may include any configuration as desired. For example, the disengagement mechanism 370 may be a hook that protrudes from the trap panel 318, or a recess formed in the trap panel 318 that defines a finger grip.

The stink bug trap 310 is otherwise similar to the stink bug trap 10 shown in FIGS. 2A-2C. That is, the stink bug trap 310 and its components may be made from similar materials as that of the stink bug trap 10, and may have similar shapes and dimensions as that of the stink bug trap 10. For example, as with the stink bug trap shown in FIGS. 2A-2C, the first sticky surface 330 of the trap panel 318 of the stink bug trap 310 will be spaced apart from the window by a distance that is between about 0.125 inches and about 1.5 inches, more particularly between about 0.25 inches and about 0.75 inches, and even more particularly about 0.25 inches when the trap panel 118 is coupled to the target surface 14. Moreover, the stink bug trap 310 may operate in a similar manner as the stink bug trap 10, and may be replaced with a new stink bug trap after the initial trap gets full.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description. Furthermore, any features of one described embodiment can be applicable to the other embodiments described herein. For example, the stink bug trap 110 may be configured to have a trap panel that includes slots similar to the stink bug traps 210 and 310.

What is claimed:

1. A stink bug trap comprising:
a trap panel that includes an inner sticky surface and an opposed outer surface, the inner sticky surface configured to immobilize a stink bug, and
at least one coupling member that extends from the trap panel along a lateral direction that extends from the outer surface toward the inner sticky surface, the at least one coupling member is configured to couple the trap panel to a target surface and has a lateral width that is between about 0.125 inches and about 1.5 inches such that at least a major portion of the inner sticky surface of the trap panel is spaced apart from the target surface by a distance that is between about 0.125 inches and about 1.5 inches when the stink bug trap is coupled to the target surface.

2. The stink bug trap of claim 1, wherein the outer surface is an outer sticky surface that faces away from the target surface when the stink bug trap is coupled to the target surface.

3. The stink bug trap of claim 1, wherein the trap panel includes an insect attractant.

4. The stink bug trap of claim 1, wherein the at least one coupling member has a lateral width that is between about 0.25 inches and about 0.75 inches such that the at least a major portion of the inner sticky surface of the trap panel is spaced apart from the target surface by a distance that is between about 0.25 inches and about 0.75 inches when the stink bug trap is coupled to the target surface.

5. The stink bug trap of claim 1, wherein the at least one coupling member has a lateral width that is about 0.25 inches such that the at least a major portion of the inner sticky surface of the trap panel is spaced apart from the target surface by a distance of about 0.25 inches when the stink bug trap is coupled to the target surface.

6. The stink bug trap of claim 1, wherein the at least one coupling member is configured to couple to glass.

7. The stink bug trap of claim 1, wherein the trap panel defines at least a first side and a second side adjacent the first side, the first side extends along a longitudinal direction that is perpendicular to the lateral direction, and the second side extends along a transverse direction that is perpendicular to both the lateral and longitudinal directions, the trap panel further includes a first side wall that extends from the first side along the lateral direction, and a second side wall that extends from the second side along the lateral direction to thereby define a corner.

8. The stink bug trap of claim 1, wherein the first and second side walls have a lateral width that is substantially equal to the lateral width of the at least one coupling member.

9. The stink bug trap of claim 1, wherein the trap panel includes a panel body that defines at least two strips that are each separated by a slot that extends laterally through the panel body.

10. A stink bug trap configured to be coupled to a window frame for a window, the window frame having at least a first dimension, the stink bug trap comprising:
a trap panel that includes a panel body that has at least one dimension that is substantially equal to the first dimension such that the trap panel is configured to have an interference fit with the window frame to thereby couple the stink bug trap to the window frame, the panel body includes an inner sticky surface configured to immobilize stink bugs, an opposed outer surface, and defines a plurality of strips that are each separated by a slot that extends laterally through the panel body,
wherein the stink bug trap is configured to be coupled to the window frame such that the inner sticky surface of the panel body is spaced apart from the window by a gap.

11. The stink bug trap of claim 10, wherein the gap is between about 0.125 inches and about 1.5 inches.

12. The stink bug trap of claim 11, wherein the gap is between about 0.25 inches and about 0.75 inches.

13. The stink bug trap of claim 10, wherein the outer surface is an outer sticky surface that faces away from the target surface when the stink bug trap is coupled to the target surface.

14. The stink bug trap of claim 10, wherein the trap panel includes an insect attractant.

15. A method of trapping stink bugs, the method comprising:
providing a stink bug trap that includes a trap panel and at least one coupling member that extends from the trap panel along a lateral direction, the trap panel having an inner sticky surface that is configured to immobilize a stink bug, the at least one coupling member has a lateral width that is between about 0.125 inches and about 1.5 inches, and
attaching the stink bug trap to a window such that the stink bug trap is positioned proximate to a corner of the window, and the inner sticky surface faces the window and is spaced apart from the window by a gap that is substantially equal to the lateral width of the at least one coupling member.

16. The method of claim 16, wherein the lateral width of the at least one coupling member is between about 0.25 inches and about 0.75 inches.

17. The method of claim 17, wherein the lateral width of the at least one coupling member is about 0.25 inches.

18. The method of claim 15, further comprising removing the stink bug trap from the window after the inner sticky surface of the trap panel has immobilized a plurality of stink bugs.

19. The method of claim 15, wherein the outer surface is an outer stick surface that is configured to immobilize stink bugs.

20. The method of claim 19, further comprising removing the stink bug trap from the window after the inner sticky surface and the outer stick surface of the trap panel have each immobilized a plurality of stink bugs.
